(19) United States
(12) Patent Application Publication
(10) Pub. No.: US 2008/0160364 A1
(43) Pub. Date: Jul. 3, 2008

(54) SOLID OXIDE FUEL CELL MODULE

(76) Inventors: Hiromi Tokoi, Tokai (JP); Kazuo Takahashi, Hitachiota (JP); Shin Takahashi, Hitachi (JP); Akira Gunji, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/953,931

(22) Filed: Dec. 11, 2007

(30) Foreign Application Priority Data
Dec. 11, 2006 (JP) 2006-333091

(51) Int. Cl. H01M 8/06; H01M 8/02; H01M 8/10

(52) U.S. Cl. 429/19; 429/26; 429/31

(57) ABSTRACT

A heat pipe is installed in a generating chamber of a module being comprised of a solid oxide fuel cell or a bundle of a plurality of solid oxide fuel cells connected in parallel or series. Preferably, the heat pipe is installed across the generating chamber and a combustion chamber for burning residual fuel unused as electrochemical reaction. By installing the heat pipe as described above, the heat transfer between both the chambers are executed smoothly, and thereby it is possible to make heat uniform in the module, in starting state, normal generating state, high power output state or abnormal state of the module.

### CLAIM OF PRIORITY

This application claims priority from Japanese application serial No. 2006-333091, filed on Dec. 11, 2006, the content of which is hereby incorporated by reference into this application.

### BACKGROUND OF THE INVENTION

The present invention relates to a solid oxide type cell module.

A fuel cell is a generating device with an electrolyte sandwiched between an anode (fuel electrode) on its one side and a cathode (air electrode) on the other side. In the device, fuel gas is fed to the anode side and oxidant gas is fed to the cathode side so that electric power is generated through the electrolyte by electrochemical reaction of the fuel and oxidant gas. A solid oxide fuel cell as one kind of the fuel cell, has not only high generation efficiency but also it has fuel reformation reaction in the fuel cell because it is operated at high temperature of 600˜1000° C.

Also, the fuel cell is capable of increasing the variety of fuels and realizing a simple structure of the fuel cell system. Therefore, it is able to decrease its cost in comparison with other fuel cells. In addition, since it has high temperature exhaust gas, the fuel cell is easy to use and feasible to form a hybrid system in not only a cogeneration system but also other system such as a gas turbine.

The solid oxide fuel cell system, however, operates at high temperature and it is prone to cause irregular temperature of the fuel cell. To solve these problems, disposing a heat pipe in the separator of flat type cell is disclosed in patent documents, for example, Japanese laid-open patent Publication Hei 9-270263 and 10-21941. Also, it is proposed to dispose a plurality of micro heat pipes in circular with gaps so as to form a fuel supply pipe, for example, Japanese laid-open patent Publication Hei-10-21941.

A method to arrange a heat pipe in a separator of flat type fuel cell or to arrange in parallel a plurality of micro heat pipes with circular so as to form fuel supplying pipe, is efficient to make temperature of each cell uniform. However, it is no effect to make temperature uniform over fuel cells as a whole of the module. Further they have no consideration of heat transfer between a generating chamber for performing fuel cell reaction (electrochemical reaction) and a combustion chamber for burning residual fuel of fuel cell reaction.

### SUMMARY OF THE INVENTION

An object of the present invention is to provide a solid oxide fuel cell module capable of making temperature (heat) uniform in not only each cell but over the all cells as a whole of the module.

A solid oxide fuel cell module of the present invention is characterized in that a heat pipe is provided at least on the inside of a generating chamber of the module comprising a solid oxide fuel cell or a block (generally called bundle or stack, hereinafter, referred to as a bundle) a plurality of the cells connected in parallel or series. Additionally, a heat pipe is disposed across a generating chamber for fuel cell reaction and a combustion chamber for burning residual fuel.

Concretely, the module of the present invention comprises a solid oxide fuel cell with an electrolyte sandwiched between an anode and a cathode, and a heat pipe disposed in at least the generating chamber.

Other aspect of the present invention is to provide a solid oxide fuel cell module comprising: an anode and a cathode on both sides of an electrolyte; a generating chamber where a fuel cell reaction occurs; and a combustion chamber adjacent to the generating chamber to burn residual fuel of the fuel cell reaction; wherein a heat pipe is disposed across the generation chamber and combustion chamber.

Other aspect of the present invention is to provide a solid oxide fuel cell module comprising: an anode and a cathode on both sides of an electrolyte; a generating chamber where a fuel cell reaction occurs; a combustion chamber adjacent to the generating chamber to burn residual fuel of the fuel cell reaction; and the module housing including the generating chamber and combustion chamber, wherein a heat pipe is disposed across the generating chamber and combustion chamber so as to penetrate the combustion chamber.

The present invention is able to apply to the module comprising to a single cell or a plurality of cells in solid oxide type.

### BRIEF DESCRIPTION OF THE DRAWINGS

FIG. 1 is a vertical-sectional view showing a solid oxide fuel cell module at starting state of an embodiment in accordance with of the present invention;

FIG. 2 is a vertical-sectional view of the solid oxide fuel cell module showing a combustion state in the combustion chamber at an ignition state;

FIG. 3 is a vertical-sectional view of the solid oxide fuel cell module showing a normal generation state;

FIG. 4 is a vertical-sectional view of the solid oxide fuel cell module at operation state of high power output;

FIG. 5 is a vertical-sectional view of the solid oxide fuel cell module showing other embodiment in accordance with the present invention;

FIG. 6 is a vertical-sectional view of solid oxide type fuel cell module of other embodiment;

FIG. 7 is a vertical-sectional view of the solid oxide fuel cell module showing the other practical mode;

FIG. 8 is a vertical-sectional view of the heat pipe used in the present invention;

FIG. 9 is a vertical-sectional view showing other example of the heat pipe;

FIG. 10 is a vertical-sectional view of other heat pipe;

FIG. 11 is a vertical-sectional view showing other example of the heat pipe;

FIG. 12 is a view in which heat uniformity effect of the present invention in comparison with that of heat pipe free; and

FIG. 13 is a cross-sectional plan view of the solid oxide fuel cell module in accordance with the present invention.

### DETAILED DESCRIPTION OF THE INVENTION

As a practical mode of the present invention, there is a case where a heat pipe is disposed across the generating chamber of modules and combustion chamber. In this case, in addition to an effect to make temperature uniform in respective cells and over the all cells, the following effect is obtained. When the temperature of the combustion chamber becomes higher than that of a generating chamber, heat is transferred from the combustion chamber to the generating chamber and as a result, an effect is obtained to increase the cell temperature rising speed. Also, when the cell temperature increases too much such as high power operation, there is an effect that heat runs away from the generating chamber to the combustion chamber to keep the cell temperature appropriate value.

Further, in other practical mode, a heat pipe is disposed across a generating chamber and combustion chamber of the module and penetrating them up to the outside of a module housing containing those chambers. In this case, in addition to the above effect, further effect is obtainable to diffuse heat to the combustion chamber when the cell heats abnormally to insure safety of the cell and module.

When disposing the heat pipe with penetrating the module hosing, it is preferable to arrange a means for using effectively discharged heat taken out to outside of the module. Using a variable conductance type heat pipe is desirable as a heat pipe, namely an insert gas type heat pipe.

The present invention may be applied to a fuel cell having any of a cell shape such as a cylindrical shape, flat shape, elliptic shape, rectangular prism shape, cubical shape or the like.

Explained below is an embodiment which a solid oxide type fuel cell module has a cylindrical shaped cell and attaches a heat pipe, however the present invention is not limited to the following embodiment.

### Embodiment

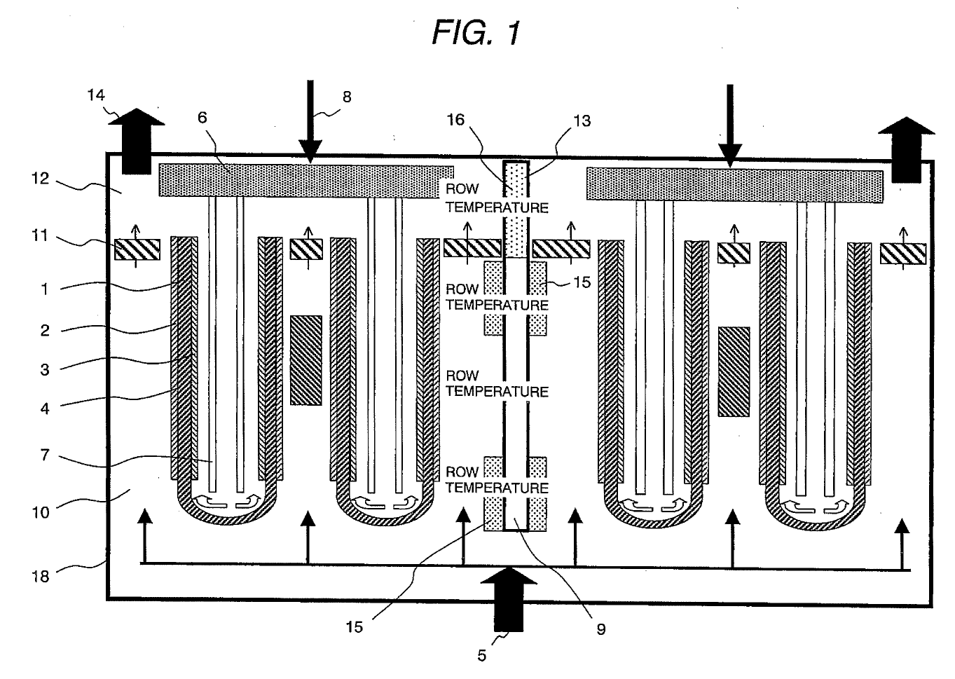

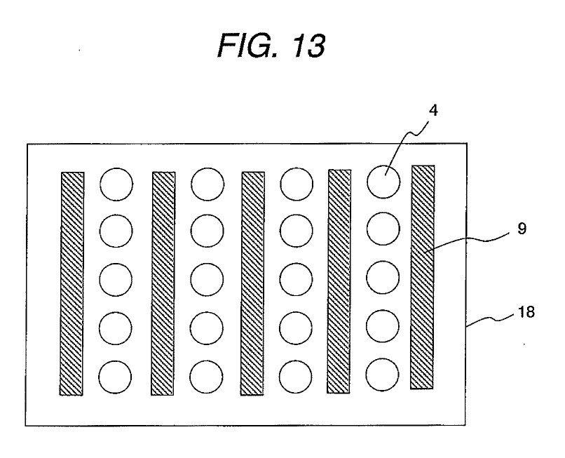

FIG. 1 shows a longitudinal section view of a solid oxide fuel cell module of an embodiment in accordance with the present invention and FIG. 13 shows a simplified cross-sectional view. A cell 4 comprises a solid electrolyte 1 with cylindrical shape, an anode 2 (fuel electrode) disposed at its outer surface and a cathode 3 (air electrode) disposed at its inner surface. Fuel gas 5 (reducing gas) is fed to an outside of the cell 4. Air 8 is fed to an inside of the cell 4 from an air pipe 7 through an air header 6. A plurality of the cells 4 are set in the module housing 18 and a heat pipe 9 is disposed between the cells respectively.

In this embodiment, the solid electrolyte 1 of each cell has tubular shape with a bottom and is made of yttrium-stabilized zirconia (YSZ). The anode 2 is made of porous cermet consisting of nickel and YSZ. The cathode 3 is made of lanthanum manganite. An inter-connector is made of lanthanum chlomide. Nickel acts as a reforming catalyst.

Here, fuel cell reaction is explained. In the first place, a method of reforming hydrocarbon fuel and generating reformed gas including hydrogen is explained, taking, for example, methane gas as the hydrocarbon fuel. Methane and steam are reacted each other (reformation reaction) on the reforming catalyst by mainly Equation (1) to generate hydrogen. In addition, a nickel base or ruthenium base catalyst is generally used as reforming catalyst.

CH₄+H₂O═CO+3H₂ (1)

A carbon oxide (CO) reacted through the Equation (1) is changed through reaction with H₂O (CO inversion reaction) expressed by Equation (2) into hydrogen and thereby becomes fuel.

CO+H₂O═CO₂+H₂ (2)

Reaction of generating hydrogen from the hydrocarbon fuel is endothermic reaction. Supplying heat requires to continue the endothermic reaction and generally it is necessary for keeping the reforming catalyst at 400˜800° C.

The electrochemical reaction (namely generating reaction or fuel cell reaction) is done at the anode 2 and expressed as the following Equations (3) and (4).

H₂+½O₂═H₂O (3)

CO+½O₂═CO₂ (4)

As the electrochemical reaction (generating reaction: fuel cell reaction) is done at the anode 2 of FIG. 1, a region where the reaction is done is called as a generating chamber.

A combustion chamber 12 is formed above the cell 4. The combustion chamber 12 is to burn residual fuel unused as the electrochemical reaction (power generation), by reacting the residual fuel with oxygen in the air unused as the electrochemical reaction. A combustion chamber 12 is separated from the generating chamber 10 with a partition plate 11. The residual fuel, after going out through the partition plate 11 from the generating chamber 10 to the combustion chamber 12, reacts and burned with oxygen in the air unused as the electrochemical reaction of the combustion chamber 12. The burned exhaust gas 14 is discharged to the outside of the module housing 18.

In FIG. 1, a heat pipe 9 is arranged across the generating chamber 10 and the combustion chamber 12.

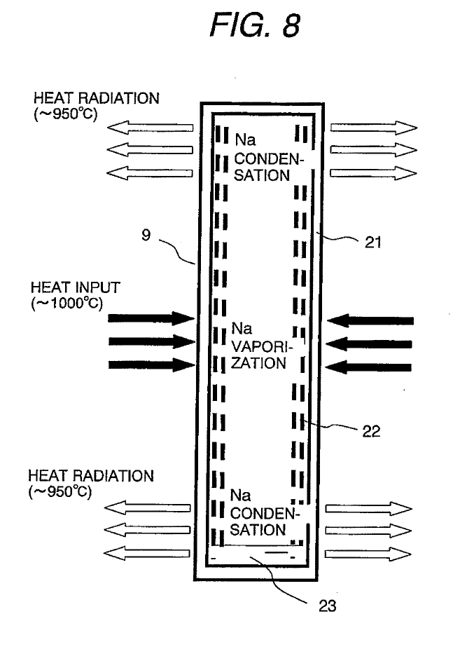

Now, explained is a heat pipe appropriate for using in the present invention. In FIG. 8, a wick 22 is attached on the inner wall of the heat pipe chamber 21, and the heat pipe chamber 21 is filled with sodium as working fluid 23. The heat pipe chamber 21 may be made of use SUS310, Inconel 600, or Cr—Fe alloy etc.. The wick may be formed by SUS316 mesh, form, or felt etc.. If the temperature at the middle position of the heat pipe in a vertical direction is higher in comparison with that of both sides, the heat transfer becomes as shown with an arrow in FIG. 8

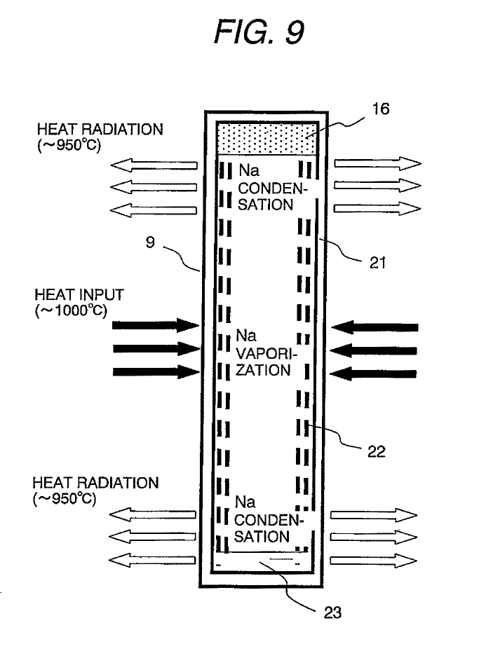

FIG. 9 is a view showing a structure which inert gas such as argon gas or nitrogen gas as insert gas 16 is contained in the heat pipe chamber 21, in addition to sodium as the working fluid 23, in the heat pipe having the same structure as that of FIG. 8. In a region where the insert gas 16 exists, since the insert gas interferes with heat transferring of sodium vapor to the heat pipe chamber, the resulting causes a reduction of the quantity of heat transferring in the heat pipe chamber 21. The heat pipe including argon gas or nitrogen gas as insert gas 16 is also called as an insert gas type heat pipe.

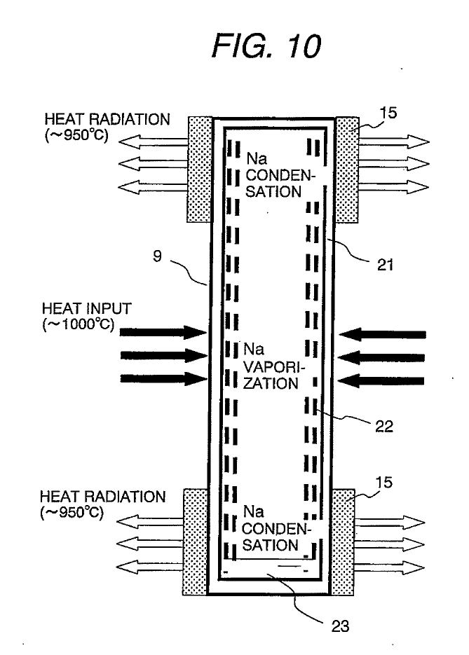

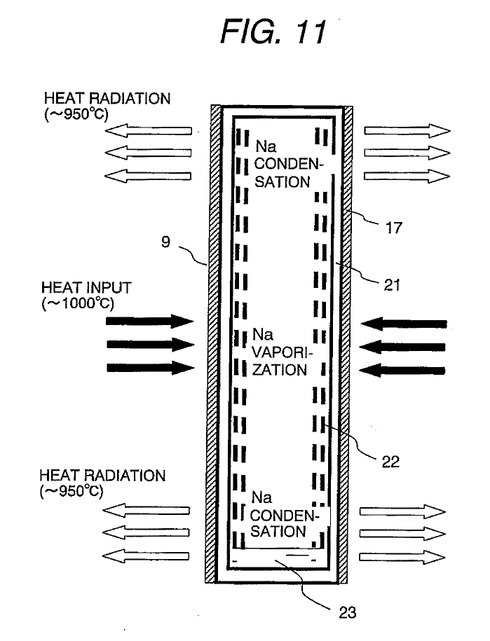

A heat pipe 9 shown in FIG. 10 has heat a transfer-fin 15 attached to an outer wall of the heat pipe chamber 21 whose inside structure is the same as that of the heat pipe shown in FIG. 8, thereby promoting heat transfer. A heat pipe 9 shown in FIG. 11 has an electric insulation layer 17 attached to an outer wall of the heat pipe chamber 21 whose inside structure is the same as that of the heat pipe shown in FIG. 8. According to the structure of the heat pipe with the electric insulation layer 17, even when fuel cells 4 having different potential are placed close to each other in the module, electric insulation between the heat pipe and its surrounding cells is ensured, thereby it is very convenient.

In addition, it is possible to use a heat pipe with combination of any functions of the heat pipes shown in FIG. 8-FIG. 11. Also, shape of the heat pipe chamber 21 may be not only a flat type but also a cylindrical type, rectangular prism type, cubic type or the like. While sodium is used as working fluid of the heat pipe, here, other heat carrier such as cesium or the like may be used for the working fluid.

In FIG. 1, the fuel cell module has insert gas type and flat type heat pipes 9 with heat transfer fins 15 attached to the outer walls of the respective heat pipe chambers 23, because the flat plate type is easy to render heat uniform over all regions of the module.

Function in the solid oxide fuel cell module is explained separately on each mode: (i) mode of the module at starting, (ii) mode at normal generation state and (iii) mode of high output power generation and abnormal heating below.

FIG. 1 corresponds to the mode (i) of the module at starting. As the module is operated at the temperature of 700° C.˜1000° C. at starting, the cell is required to make a rise in its temperature by a heating means such as a heater or burner etc.. In general, the anode side is heated in reducing atmosphere and a cathode side is heated in oxidizing atmosphere.

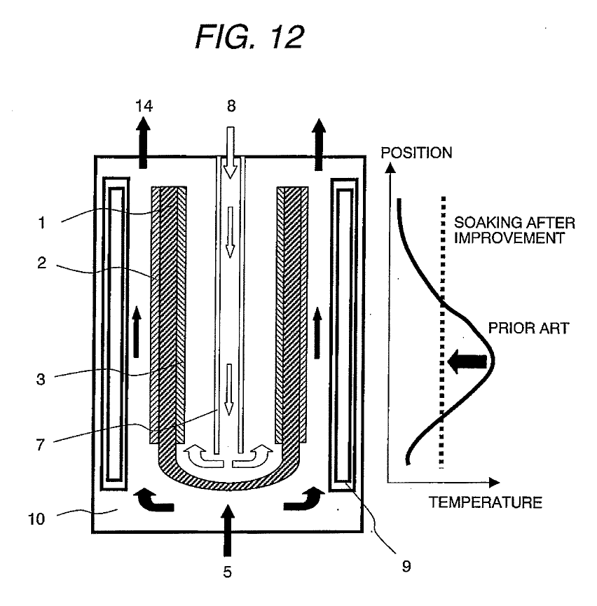

For example, high temperature fuel gas 5 is supplied from a fuel gas supply line to raise the temperature of each cell 4 from the room temperature. In this case, the rise of air temperature for cathode may be executed simultaneously. At this time, the insert gas and flat type heat pipe 9 is low temperature. Accordingly, pressure of sodium (Na) as working fluid is low, and argon gas (insert gas 16) exiting in a gas reservoir 13 of the heat pipe 9 is expanded over all region being located in the combustion chamber 12 (gas expansion state) as shown in FIG. 12.

As a result, in the inset gas and flat type heat pipe 9, a insert gas region (gas reservoir region 13) being located in the combustion chamber 12 does not perform heat transfer function as a heat pipe. That is, even when the generating chamber 10 has high temperature in comparison with combustion chamber 12, heat of the generating chamber 10 is not transferred to the combustion chamber 12. Therefore, heat of fuel gas 5 supplied from the outside to the generating chamber 10 is able to warm each cell 4 efficiently.

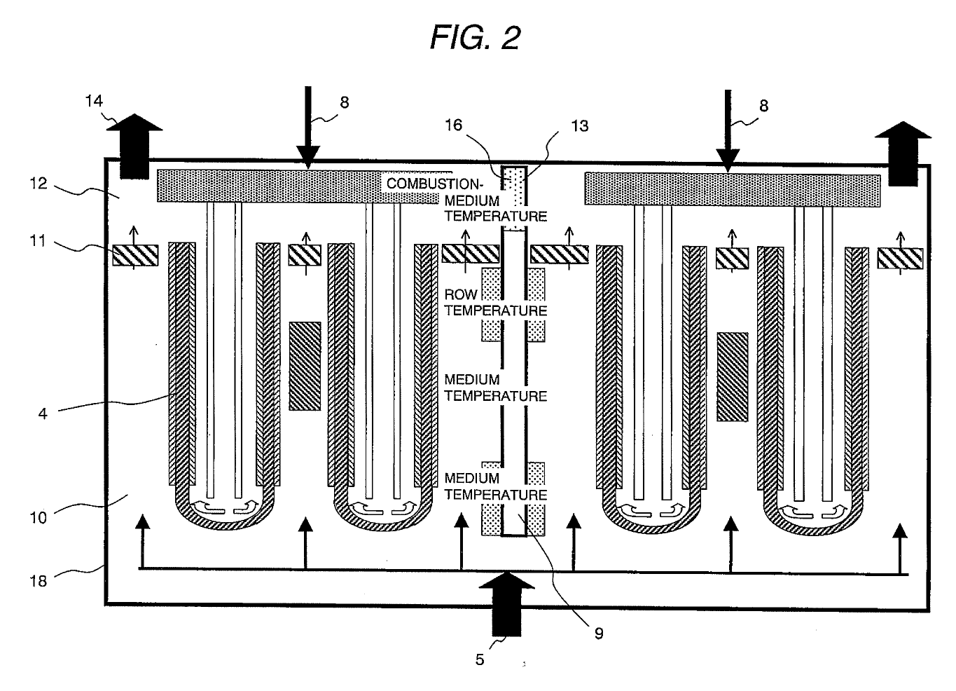

FIG. 2 shows the state of the module after ignition in the combustion chamber 12 where the temperature of the module becomes high in comparison with that of FIG. 1. In this state, the temperature of sodium as the working fluid in the heat pipe 9 goes up and the vapor pressure of sodium rises. Accordingly, the insert gas 16 in the gas reservoir 13 of the heat pipe 9 is somewhat compressed in comparison with FIG. 1 in a direction of the combustion chamber 12; and a portion of heat pipe 9 being located in the combustion chamber 12 performs a function as a heat pipe. At this time point, fuel gas 5 for heating anode 2 flowing into the combustion chamber 12 becomes also high temperature and reacts with oxidizing gas 8 for heating the cathode 3 to be burned in the combustion chamber 12.

When beginning to burn in the combustion chamber 12, the combustion chamber temperature becomes higher than that of the generating chamber 10 and the heat pipe 9 transfers heat from the higher temperature portion corresponding to the combustion chamber 12 to the lower temperature portion corresponding to the generating chamber 10. Accordingly, in comparison with a case of heat pump free, it is possible to increase temperature rising speed of the cell. Of course, as the heat pipe has a function naturally rendering internal heat thereof uniform, it is possible to raise the temperature with making the temperature uniform in the generating chamber 10.

Additionally, hydrogen, methane, LNG, town gas or the like are usable as fuel gas to be used for reducing gas.

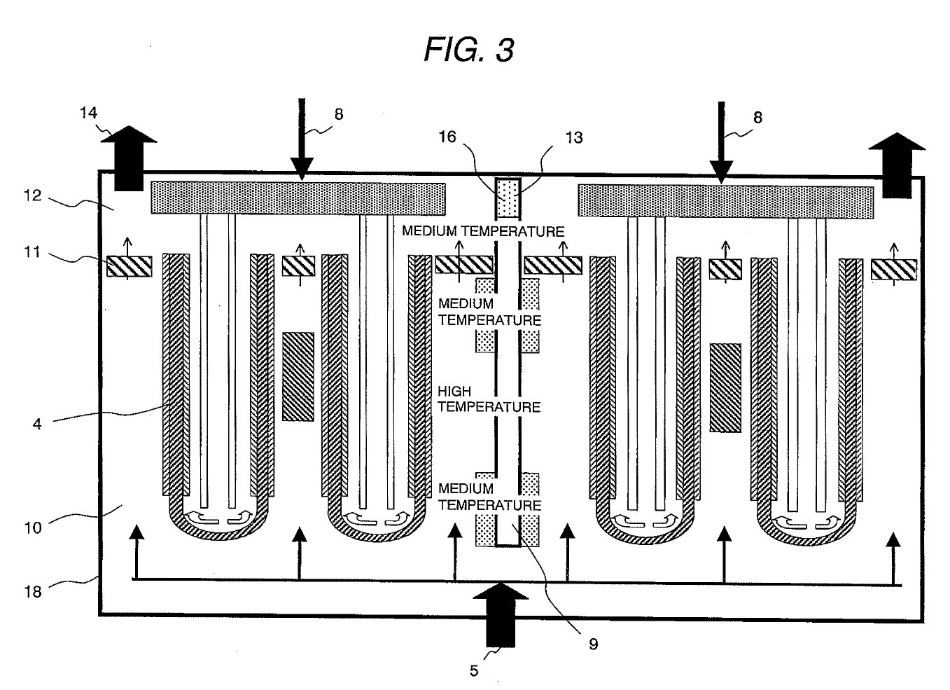

FIG. 3 shows a normal generation state of the module where the temperature of generating chamber 10 further rises up in comparison with that of FIG. 2, and the cell operation temperature becomes at 700° C.18 1000° C. capable of allowing electric current to flow through the cell. As the current flows through the cell, temperature of the cell goes up and temperature of the generating chamber 10 becomes higher than that of FIG. 2. That is, the temperature of sodium as the working fluid of the heat pipe further goes up and the vapor pressure of sodium rises too. Therefore, the insert gas 16 in the gas reservoir 13 of the heat pipe 9 is further compressed in the direction of combustion chamber 12 in comparison with FIG. 2; and in the heat pipe, almost of the portion located in the combustion chamber 12 functions as a heat pipe.

Particularly, as a general trend, although temperature at the middle area of the generating chamber 10 becomes higher than other area, according to the present embodiment, the heat pipe 9 transfers heat so as to making the temperature in the generating chamber uniform. Additionally, as middle area of the generating chamber 10 becomes frequently high in comparison with the combustion chamber 12, the heat transfer is carried out from the generating chamber 10 to the combustion chamber 12.

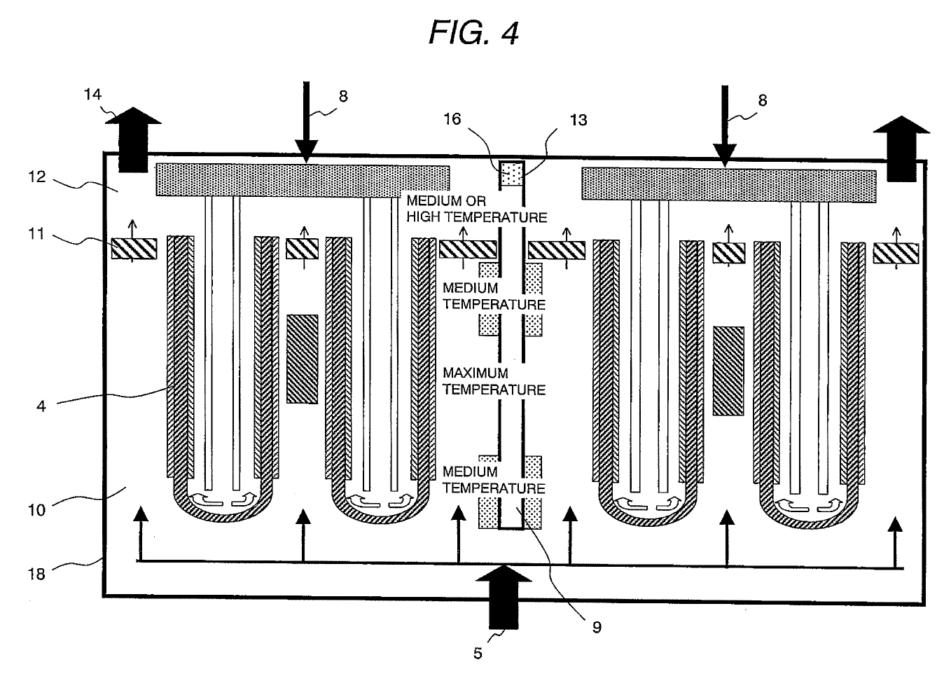

FIG. 4 shows a case of high power generation operation of the module where the generating chamber 10 generates higher output in comparison with FIG. 3. As the cell current increases, heat of the cell increases and cell temperature goes up in comparison with FIG. 3 and the middle portion of the cell shows especially maximum temperature. Therefore, increase of the temperature of sodium as the working fluid raises its vapor pressure. Therefore, the insert gas 16 in the gas reservoir 13 of the heat pipe 9, in comparison with FIG. 3, considerably is compressed toward the combustion chamber 12; and in the heat pipe 9, almost all region located in the combustion chamber 12 performs a function as a heat pipe.

Particularly, as temperature at the middle area portion of the generating chamber 10 becomes high, heat pipe 9 transfers heat so as to make the temperature in the generating chamber uniform and performs heat transfer from the middle point of the generating chamber 10 to the combustion chamber 12, and accordingly, it is possible to cool the cell essentially to maintain the cell temperature within an appropriate range, for example, 1000° C.

FIG. 4 shows the state of the module where, in addition to the high power output, some abnormal causes in the module. In this case, although the module becomes very high temperature, as the heat pipe 9 performs the function to making heat uniform over whole module and accordingly, it is effective as safety way too.

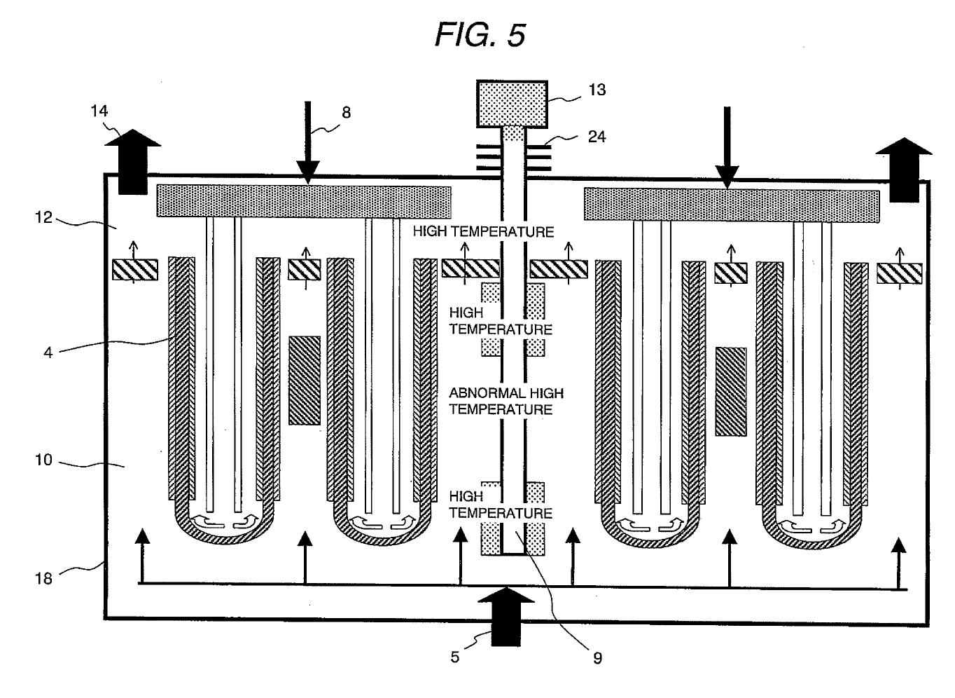

FIG. 5 is another example of the present invention and shows a structure suitable for taking out the cell heating in the generating chamber to the outside of the module. In FIG. 3 and FIG. 4, it is explained that radiation from the high temperature portion of the generating chamber 10 of the module is necessary during cell generation state. In FIG. 5, heat from the module is taken out outside to render it reusable. Therefore, a gas reservoir 13 is disposed on outside of the module and a fin 24 is provided on outside of the module so that the gas reservoir 13 acts as a heat exchanger for heat exchange.

According to the embodiment shown in FIG. 5, in addition to the high power output, even if some abnormal occurs in the module to become high temperature, since the heat pipe 9 can have a function to make heat uniform over whole module with an extremely high efficiency, it is effective as safety way too. With regard the other functions, the structure in the module of FIG. 5 has also the same functions as the module shown in FIG. 1-FIG. 4.

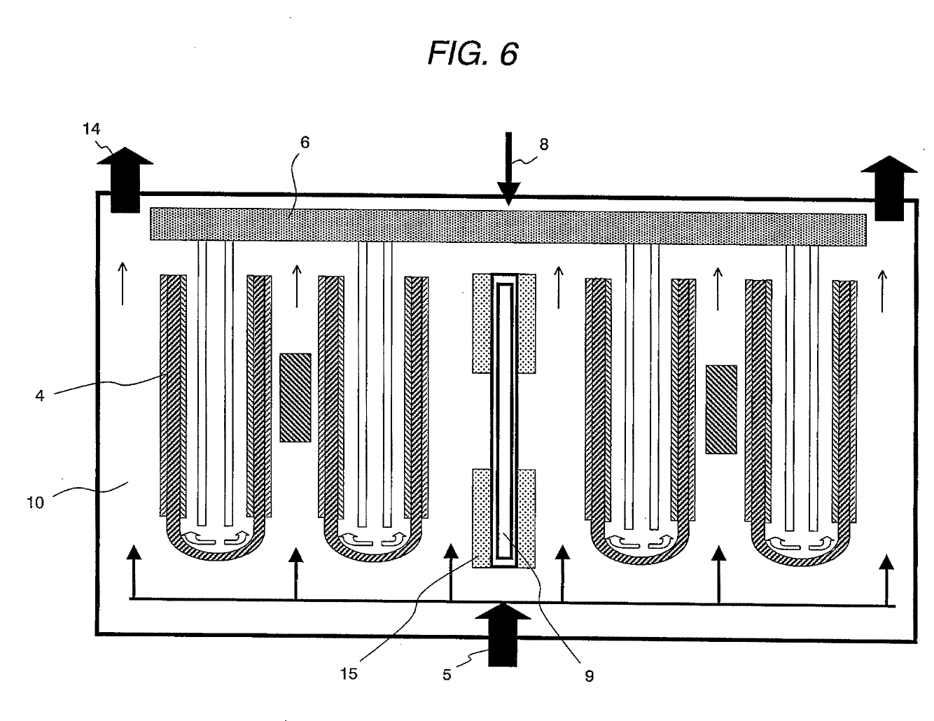

FIG. 6 is another example of the present invention where the heat pipe 9 is disposed on only a generating chamber 10. This structure enables to only make the temperature of the generating chamber uniform.

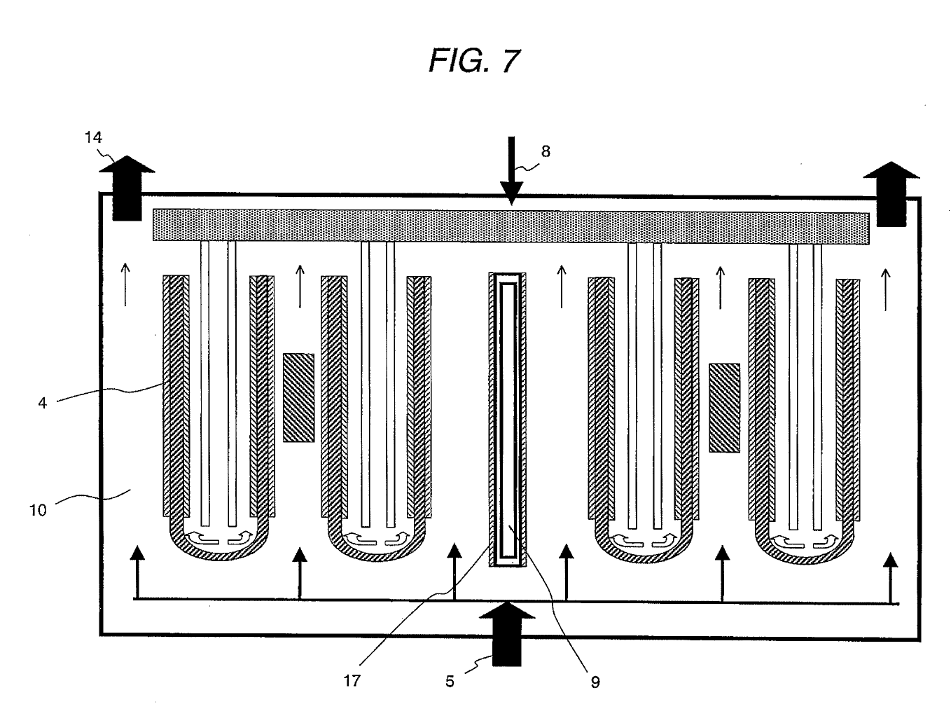

FIG. 7 shows another example of the present invention where an electric insulation layer 17 is arranged on the outer surface of heat pipe 9 in the module. According to this embodiment, even when a large number of cells are disposed close to each other, the insulation may maintain between the heat pipe 9 and its surrounding cells. In the embodiment shown in FIG. 7, the heat pipe 9 is disposed only the generating chamber 10. In this structure, it is possible to make the temperature of only generating chamber uniform.

Furthermore, while the heat pipe 9 is not provided with the insert gas 16 in embodiments of FIG. 6 and FIG. 7, even when using the insert gas in the heat pipe, it may be effective for the function of the heat pipe.

FIG. 12 is a typical example of heat uniformity effect of the present invention. In the case of heat pipe free which is shown as PRIOR ART, temperature of the middle portion of the cell is extremely higher than the other portions. On the other hand, according to the present invention, whole cell temperature can be made uniform by “heat uniformity after improvement” with heat pipe.

Practical modes of the present invention are explained above taking flat type heat pipe, however, the shape of the heat pipe may be a cylindrical shape, rectangular prism shape or the like.

In the above explanation, the cell has a structure where the anode is disposed on the outside of the cylindrical shaped cell and the cathode is disposed on the inside thereof. However, the present invention may be applicable with same effect to a cell structure whose cathode is disposed outside of the cell and anode is disposed inside thereof. Also, although the cell is explained by cylindrical tube with a bottom, it may be applicable by bottomless tube with the sufficient effect. Also, the present invention may be applicable to not only cylindrical shape cell, but also a flat cylindrical shape, elliptic shape, rectangular prism shape, cubical shape cell, or obtainable same effect.

According to the present invention, it is capable of making temperature (heat) uniform in not only each cell but over the all cells as a whole of the module, as a result, generation performance of cells is improved.

What is claimed is:

1. A solid oxide fuel cell module comprising:
an anode;
a cathode; and
an electrolyte sandwiched between said anode and cathode;
wherein a heat pipe is disposed in a generating chamber where fuel cell reaction occurs.

2. The solid oxide fuel cell module according to claim 1,
wherein a solid oxide fuel cell including said anode, cathode, and electrolyte has a flat shape, rectangular prism shape or cylindrical shape.

3. The solid oxide fuel cell module according to claim 1,
wherein said anode is disposed on the outside of said electrolyte and said cathode is disposed on the inside of said electrolyte, and
wherein a solid oxide fuel cell including said anode cathode, and electrolyte has a cylindrical shape or flat shape.

4. The solid oxide fuel cell module according to claim 1,
wherein the module is formed with a bundle of solid oxide fuel cells being connected in parallel or series to each other, and said heat pipe is disposed in the generating chamber of the module.

5. The solid oxide fuel cell module according to claim 1,
wherein said anode and cathode are respectively placed on both sides of said electrolyte and a combustion chamber for burning residual fuel adjacent to the generating chamber where fuel cell reaction occurs, said heat pipe being arranged across said generating chamber and combustion chamber.

6. The solid oxide fuel cell module according to claim 5,
wherein said electrolyte is sandwiched between said anode on the outside and said cathode on the inside, and a solid oxide fuel cell including said anode, cathode, and electrolyte has a cylindrical shape or flat shape.

7. The solid oxide fuel cell module according to claim 5,
wherein a gas reservoir for insert gas of said heat pipe is located in said combustion chamber.

8. The solid oxide fuel cell module according to claim 5,
wherein the module is formed with a bundle of a plurality of solid oxide fuel cell connected in parallel or series to each other.

9. A solid oxide fuel cell module comprising;
an anode;
a cathode;
an electrolyte being sandwiched between said anode and cathode on its both sides of said electrolyte;
a generating chamber where a fuel cell including said anode, cathode and electrolyte is contained to occur fuel cell reaction
a combustion chamber for burning residual fuel of fuel cell reaction, which is adjacent to the generating chamber;
wherein a heat pipe is disposed across said generating chamber and combustion chamber so as to penetrate said combustion chamber.

10. The solid oxide fuel cell module according to claim 9,
wherein said anode is disposed on the outside of said electrolyte and the cathode is disposed on the inside of said electrolyte, and
wherein said cell has a cylindrical shape or flat shape.

11. The solid oxide fuel cell module according to claim 9,
wherein a gas reservoir for insert gas of said heat pipe is disposed on the outside of a module housing including said generating chamber and combustion chamber.

12. The solid oxide fuel cell module according to claim 9,
wherein a heat radiation region of said heat pipe is positioned on the outside of a module housing including said generating chamber and combustion chamber.

13. The solid oxide fuel cell module according to claim 9,
wherein the module is formed with a bundle of solid oxide fuel cells being connected in parallel or series to each other.

14. The solid oxide fuel cell module according to claim 1,
wherein said heat pipe is a variable conductance type.

15. The solid oxide fuel cell module according to claim 1,
wherein said heat pipe has an electric insulation layer on its outer surface.

16. The solid oxide fuel cell module according to claim 1,
wherein said heat pipe is a variable conductance type and plane type.

17. The solid oxide fuel cell module according to claim 1,
wherein sodium or cesium is used as a heat carrier of said heat pipe.
